(19) United States
(12) Patent Application Publication
(10) Pub. No.: US 2013/0215770 A1
(43) Pub. Date: Aug. 22, 2013

(54) METHOD AND APPARATUS FOR SELECTING WIRELESS ACCESS NETWORK BASED ON CONTENTS CHARACTERISTIC

(71) Applicant: YOUNG IL KIM, Daejeon-si (KR)

(72) Inventor: YOUNG IL KIM, Daejeon-si (KR)

(73) Assignee: Electronics and Telecommunications Research Institute, Daejeon-si (KR)

(21) Appl. No.: 13/572,242

(22) Filed: Aug. 10, 2012

(30) Foreign Application Priority Data
Feb. 21, 2012 (KR) 10-2012-0017302

(51) Int. Cl. H04W 48/18; H04W 88/16; H04W 36/24; H04W 24/00

(52) U.S. Cl. 370/252; 370/328; 370/338

(57) ABSTRACT

A method and an apparatus for selecting wireless access networks in wireless communication systems including a plurality of wireless access networks are provided. A broadcasting/communication server for a multi access network includes a wireless access network wireless resource cost comparing module configured to select one wireless access network by calculating a cost function of each of the plurality of wireless access networks, based on wireless traffic information of each wireless access network received from the plurality of wireless access networks and contents information to be provided to terminals; a wireless router control module configured to control a path of a contents based router with the selected one wireless access network; and a network matching module configured to be connected to the plurality of wireless access network through the contents based router.

### CROSS-REFERENCE TO RELATED APPLICATIONS

This application claims the benefit of priority of Korean Patent application No. 10-2012-0017302 filed on Feb. 21, 2012, which is incorporated by reference.

### BACKGROUND OF THE INVENTION

1. Field of the Invention

The present invention relates to wireless communication, and more particularly, to a method and an apparatus for selecting one wireless access networks based on contents characteristics in wireless communication systems including a plurality of wireless access networks.

2. Related Art

Recently, loads on wired networks or wireless networks have been rapidly increased due to an increase in multimedia contents such as HD broadcasting. In particular, there is a limitation in frequencies that can be used as wireless resources of wireless access networks. Therefore, an efficient use of the frequencies according to characteristics of wireless access networks has been demanded.

The wireless access networks may each have different characteristics. For example, a Wi-Fi network provides low-speed mobility, but may provide broadband transmission of data in a short range at low cost. On the other hand, mobile networks such as 3^{rd} generation partnership project (3GPP), mobile WiMax, and the like, supports high-speed mobility, but has characteristics suitable to transmit low-speed data, as compared with the Wi-Fi network. Therefore, a terminal selects appropriate wireless access networks according to characteristics of each wireless access network, if possible, and thus, efficient communications can be expected.

When the terminal intends to select appropriate wireless access networks, the terminal may select the wireless access networks due to various factors in addition to characteristics of each wireless access network. In particular, contents characteristics transmitted and received to and from the terminal may be a reference selecting the wireless access networks and a technology thereof may be proposed.

### SUMMARY OF THE INVENTION

The present invention provides a method and an apparatus for selecting a single wireless access network based on contents characteristics in wireless communication systems including a plurality of wireless access networks. Further, the present invention provides a method for selecting optimal wireless access networks in consideration of contents characteristics based on traffic information provided by each wireless access network in wireless communication systems in which various wireless access networks such as 3GPP, mobile WiMax, WiFi, and the like, are present.

In an aspect, a broadcasting/communication server for a multi access network in wireless communication systems including a plurality of wireless access networks is provided. The broadcasting/communication server for a multi access network includes a wireless access network wireless resource cost comparing module configured to select one wireless access network by calculating a cost function of each of the plurality of wireless access networks, based on wireless traffic information of each wireless access network received from the plurality of wireless access networks and contents information to be provided to terminals, a wireless router control module, operatively coupled to the wireless access network wireless resource cost comparing module, and configured to control a path of a contents based router with the selected one wireless access network, and a network matching module configured to be connected to the plurality of wireless access network through the contents based router.

The cost function may be calculated based on the following Equation Cost=Weight ×{(Contents required transmission rate)/(Allowable transmission rate in consideration of delay of each wireless access network)}×(cost of each wireless access network/bit), where the weight is a parameter in consideration of characteristics of each wireless access network.

The one wireless access network may be selected as a wireless access network having the smallest cost function calculated.

The wireless traffic information of each wireless access network may include at least one of wireless resource allocation information of each wireless access network, available wireless resource information, and interference information within each wireless access network.

The wireless traffic information of each wireless access network may be periodically received from each wireless access network.

The contents information may include at least one of a bandwidth, a delayed value, and contents characteristics.

In another aspect, a method for selecting wireless access networks in wireless communication systems including a plurality of wireless access networks is provided. The method includes receiving wireless traffic information of each wireless access network from the plurality of wireless access networks, receiving a contents transmission request from terminals selecting one wireless access network by calculating a cost function of each of the plurality of wireless access networks, based on the wireless traffic information of each wireless access network and contents information to be provided to the terminals, and transmitting contents to the terminals through the selected one wireless access network.

The cost function may be calculated based on the following Equation: Cost=Weight ×{(Contents required transmission rate)/(Allowable transmission rate in consideration of delay of each wireless access network)}×(cost of each wireless access network/bit), where the weight is a parameter in consideration of characteristics of each wireless access network.

The one wireless access network may be selected as a wireless access network having the smallest cost function calculated.

The wireless traffic information of each wireless access network may include at least one of wireless resource allocation information of each wireless access network, available wireless resource information, and interference information within each wireless access network.

The wireless traffic information of each wireless access network may be periodically received from each wireless access network.

The contents information may include at least one of a bandwidth, a delayed value, and contents characteristics.

The method may further include controlling a path of a contents based router with the selected one wireless access network.

The method may further include, when the selected one wireless access network is different from a wireless access network to which the terminals are currently accessed, performing a handover to the selected one wireless access network from the wireless access network to which the terminals are currently accessed.

The performing of the handover may include transmitting an inter-system handover enable message to a wireless access network to which the terminals are currently accessed and the selected one wireless access network.

In another aspect, a signal converting apparatus between a wireless access network in wireless communication systems including a plurality of wireless access networks is provided. The signal converting apparatus includes a target physical/MAC layer processing unit configured to convert wireless signals of other wireless access networks among the plurality of wireless access networks into wireless signals of the targeted wireless access network and process a physical/multimedia access control (MAC) layer of the targeted wireless access network, and at least one source physical/MAC layer processing unit configured to process the physical/MAC layer of the other wireless access network.

The targeted wireless access network may be a Wi-Fi network.

The other wireless access network may be one of a 3^{rd} generation partnership project (3GPP) long term evolution (LTE) network, an international mobile telecommunications (IMT)-advance WiBro network, and a Wibro/Mobile WiMax network.

The target physical/MAC layer processing unit may be further configured to communicate with a single mode terminal.

In another aspect, a communication method in wireless communication systems including a plurality of wireless access networks is provided. The communication method includes receiving wireless signals of other wireless access networks among the plurality of wireless access networks and converting the received wireless signals into wireless signals of a targeted wireless access network, processing a physical/media access control (MAC) layer of the targeted wireless access network, and communicating with a single mode terminal through the targeted wireless access network.

### BRIEF DESCRIPTION OF THE DRAWINGS

FIG. 1 is a diagram showing an example of a configuration diagram of a wireless access network according to an exemplary embodiment of the present invention.

FIG. 2 is a diagram showing an example of a broadcasting/communication server for a multi access network and a contents based router according to an exemplary embodiment of the present invention.

FIG. 3 is a diagram showing an example of a 3GPP LTE base station of a wireless access network according to an exemplary embodiment of the present invention.

FIG. 4 is a diagram showing an example of a Wi-Fi single mode terminal according to the exemplary embodiment of the present invention.

FIG. 5 is a diagram showing an example of a multi mode terminal according to the exemplary embodiment of the present invention.

FIG. 6 is a diagram showing an example of a signal converting apparatus between wireless access networks according to an exemplary embodiment of the present invention.

FIG. 7 is a diagram showing a method for selecting a wireless access network according to an exemplary embodiment of the present invention.

FIG. 8 is a diagram showing a method for selecting a wireless access network according to another exemplary embodiment of the present invention.

### DESCRIPTION OF EXEMPLARY EMBODIMENTS

Hereinafter, exemplary embodiments of the present invention so as to be easily practiced by a person skilled in the art to which the present invention pertains will be described in detail with reference to the accompanying drawings. However, the present invention may be implemented in various types and therefore, is not limited to exemplary embodiments described herein. In the accompanying drawings, portions unrelated to the description will be omitted in order to obviously describe the present invention, and similar reference numerals will be used to describe similar portions throughout the present specification. Further, when a detailed description is omitted, only a detailed description of portions that may be easily understood by those skilled in the art will be omitted.

Throughout the specification, unless explicitly described otherwise, “comprising” any components will be understood to imply the inclusion of other components but not the exclusion of any other components.

An exemplary embodiment of the present invention is based on a wireless communication system that can access various wireless access networks, by including a signal converting apparatus in which a terminal itself can access a plurality of wireless access networks or a terminal can interlock the plurality of wireless access networks. The exemplary embodiment of the present invention proposes a method for providing optimal services to users through optimal wireless access networks selected based on traffic environment characteristics and contents characteristics of each of the wireless access networks in the wireless communication systems. To this end, the exemplary embodiments of the present invention provides services through wireless access networks by allowing base stations of each wireless access network to periodically traffic parameters, such as wireless resource allocating situations, interference within the wireless access networks, and the like, to a broadcasting/communication server for a multi access network and allowing a broadcasting/communication server for a multi access network to calculate cost based on the traffic parameters and provide services at minimum costs.

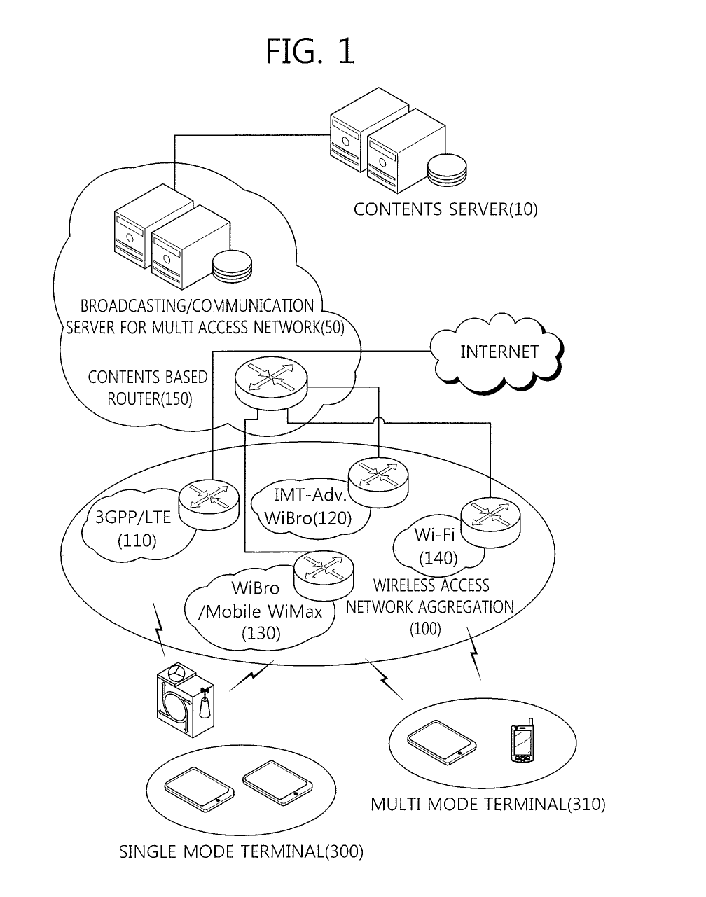

FIG. 1 is a diagram showing an example of a configuration diagram of a wireless access network according to an exemplary embodiment of the present invention.

FIG. 1 shows a diagram showing a configuration of a wireless access network. The wireless access network includes: a contents server 10, a broadcasting/communication server 50 for a multi access network, a wireless access network aggregation 100 including a plurality of wireless access networks 110, 120, 130, and 140, a contents based router 150, and a plurality of terminals 300 and 310.

The contents server 10 transmits contents requested by a terminal and various pieces of information related to corresponding contents to the broadcasting/communication server 50 for a multi access network.

The broadcasting/communication server 50 for a multi access network periodically receives traffic information periodically provided by base stations within a plurality of wireless access networks 110, 120, 130, and 140. In the exemplary embodiment of the present invention, it is assumed that the wireless access network aggregation 100 includes a 3^{rd} generation partnership project (3GPP) long term evolution (LTE) 110, an international mobile telecommunications (IMT)-advance WiBro 120, a Wibro/Mobile WiMax 130, and a Wi-Fi 140, but is not limited thereto and may include other wireless access networks. The traffic information may include wireless resource allocation information of each wireless access network, available wireless resource information, interference within each wireless access network, and the like.

The broadcasting/communication server 50 for a multi access network calculates a cost function in consideration of requirements of contents provided to the terminal based on traffic information of each wireless access network 110, 120, 130, and 140. The requirements of the contents may include traffic attributes, and the like, such as a bandwidth, a delayed allowable value, video on demand (VoD)/real TV, and the like. The broadcasting/communication server 50 for a multi access network may select optimal wireless access networks based on the cost function. The cost function may be calculated in different manner for each provider. Here, Equation 1 shows an example of Equation calculating the cost function.

Cost=Weight×{(Contents required transmission rate)/(Allowable transmission rate in consideration of delay of each wireless access network)}×(cost of each wireless access network/bit) [Equation 1]

In Equation 1, Weight is a parameter in consideration of characteristics of each wireless access network. For example, when the allowable transmission rate is large in each wireless access network, interference from neighboring base stations is small and therefore, high-quality video services may be continuously provided. The characteristics of the wireless access networks may be reflected to a weight parameter.

The broadcasting/communication server 50 for a multi access network may select the optimal wireless access networks based on the cost function calculated. In addition, the broadcasting/communication server 50 for a multi access network controls a path of the contents based router 150 so that the contents received from the contents server 10 may be transmitted to the selected wireless access networks. The contents based router 150 routes the contents received from the contents server 10 to the selected wireless access network. The selected one wireless access network transmits contents to the terminals 300 and 310.

In the wireless communication system, the terminal is classified into a single mode terminal 300 and a multi mode terminal 310. The single mode terminal 300 means a terminal that can communicate with a specific one wireless access network. For example, the single mode terminal 300 can perform communication through only the Wi-Fi network. The single mode terminal 300 may receive signals from other wireless access network through a signal converting apparatus 200 between the wireless access networks. That is, the single mode terminal 300 that can perform communication through the Wi-Fi network can communicate with the 3GPP LTE network through the signal converting apparatus 200 between the wireless access networks, when the wireless access network selected by the broadcasting/communication server 50 for a multi access network is the 3GPP LTE. In this case, the signal converting apparatus 200 between the wireless access networks may serve as a relay that performs processes for a physical and media access control (MAC) layer and then, retransmits signals by the wireless access network type in which the single mode terminal can perform communication.

The multi mode terminal 310 means a terminal that can communicate with the plurality of wireless access networks rather than with a specific one access network. Smart phones may be an example of the multi mode terminal. The multi mode terminal 310 may originally receive and process the signals transmitted by the wireless access networks selected by the broadcasting/communication server 50 for a multi access network. Therefore, the signal converting apparatus 200 between the wireless access networks like the single mode terminal 300 is not needed.

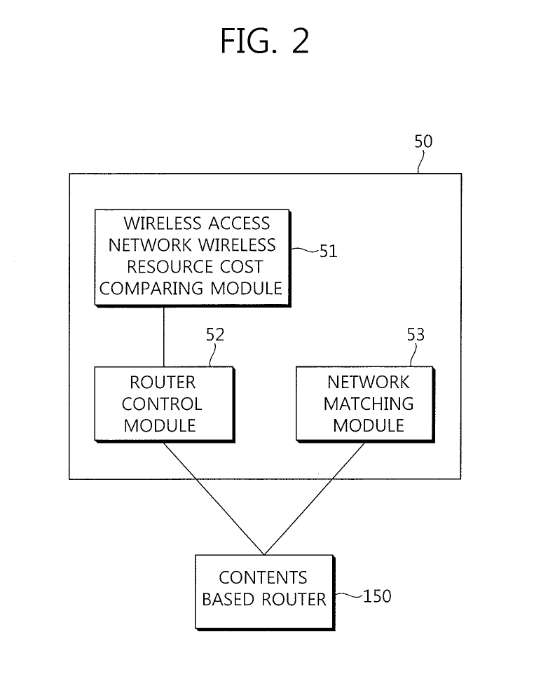

FIG. 2 is a diagram showing an example of a broadcasting/communication server for a multi access network and a contents based router according to an exemplary embodiment of the present invention.

Referring to FIG. 2, the broadcasting/communication server 50 for a multi access network includes a wireless access network wireless resource cost comparing module 51, a router control module 52, and a network matching module 53. The wireless access network wireless resource cost comparing module 51 calculates the cost function in consideration of requirements of contents provided to the terminal based on the traffic information of each wireless access network. The cost function may be calculated, for example, by the above Equation 1. The wireless access network wireless resource cost comparing module 51 may select the optimal wireless access networks based on the cost function. The cost function may be calculated by different manners for each provider. The router control module 52 is connected with the wireless access network wireless resource cost comparing module 51 and controls the contents based router 150 that connects the broadcasting/communication server 50 for a multi access network to each wireless access network. The network matching module 53 is connected with network matching gateways of each wireless access network through the contents based router 150. The broadcasting/communication server 50 for a multi access network may be interlocked with each wireless access network through the network matching module 53 and the contents based router 150.

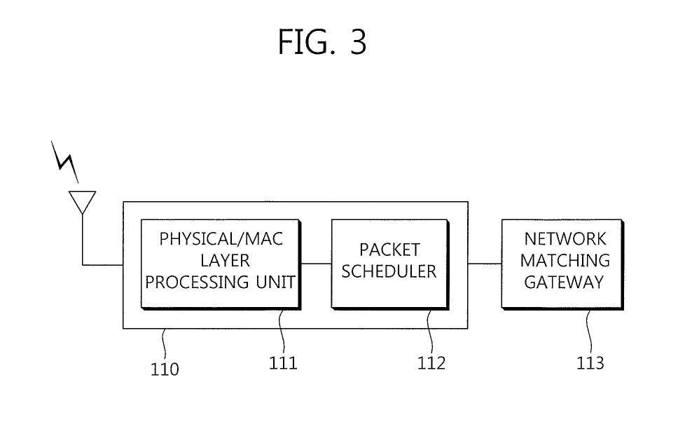

FIG. 3 is a diagram showing an example of a 3GPP LTE base station of a wireless access network according to an exemplary embodiment of the present invention.

Referring to FIG. 3, the 3GPP LTE base station 110 includes a physical/MAC layer processing unit 111 and a packet scheduler 112 and is connected with a network matching gateway 113. The physical/MAC layer processing unit processes the physical/MAC layer of the 3GPP LTE network and the packet scheduler allocates the wireless resources to the wireless access network. The 3GPP LTE base station 110 may be connected with the broadcasting/communication server for a multi access network through the network matching gateway 113 and the contents based router.

Meanwhile, FIG. 3 shows, by way of example, the 3GPP LTE base station 110 using the 3GPP LTE network among the wireless access networks shown in FIG. 1 as an example but is not limited thereto. Architecture of the base station of FIG. 3 may be used as architecture of the base stations of various wireless access networks. For example, FIG. 3 shows any one of IMT-Adv WiBro base station 120, the WiBro/Mobile WiMax base station 130, and the Wi-Fi base station 140. That is, the IMT-Adv WiBro base station 120 includes a physical/MAC layer processing unit 121 and a packet scheduler 122 and is connected with a network matching gateway 113. The WiBro/Mobile WiMax base station 130 includes a physical/MAC layer processing unit 131 and a packet scheduler 132 and is connected with a network matching gateway 133. The Wi-Fi base station 140 includes a physical/MAC layer processing unit 141 and a packet scheduler 142 and is connected with a network matching gateway 143.

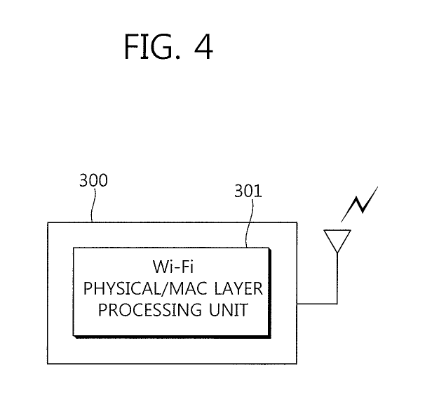

FIG. 4 is a diagram showing an example of a Wi-Fi single mode terminal according to the exemplary embodiment of the present invention.

Referring to FIG. 4, the Wi-Fi single mode terminal 300 includes a Wi-Fi physical/MAC layer processing unit 301. The Wi-Fi physical/MAC layer processing unit 310 receives Wi-Fi signals and processes the physical/MAC layer of the Wi-Fi signals. FIG. 4 shows the Wi-Fi single mode terminal by way of example, but is not limited thereto. The single mode terminal of FIG. 4 may be any one of a 3GPP LTE single mode terminal, an IMT-Adv WiBro single mode terminal, and a WiBro/Mobile WiMax single mode terminal. The Wi-Fi single mode terminal 300 according to the exemplary embodiment of the present invention can communicate with different types of wireless access networks through the signal converting apparatus between the wireless access networks.

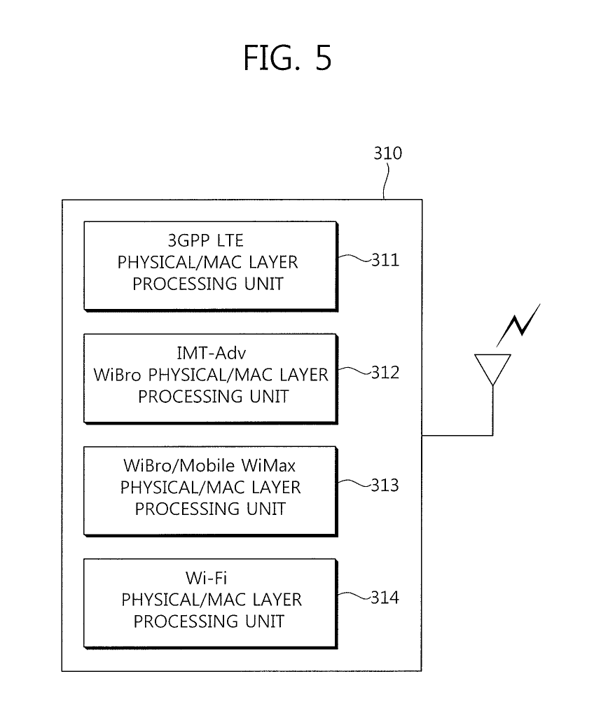

FIG. 5 is a diagram showing an example of a multi mode terminal according to the exemplary embodiment of the present invention.

Referring to FIG. 5, the multi-mode terminal 310 includes a 3GPP physical/MAC layer processing unit 311, an IMT-Adv WiBro physical/MAC layer processing unit 312, a WiBro/Mobile WiMax physical/MAC layer processing unit 313, and a Wi-Fi physical/MAC layer processing unit 314. Therefore, the multi mode terminal 310 may directly communicate with various types of wireless access networks without the signal converting apparatus between the wireless access networks.

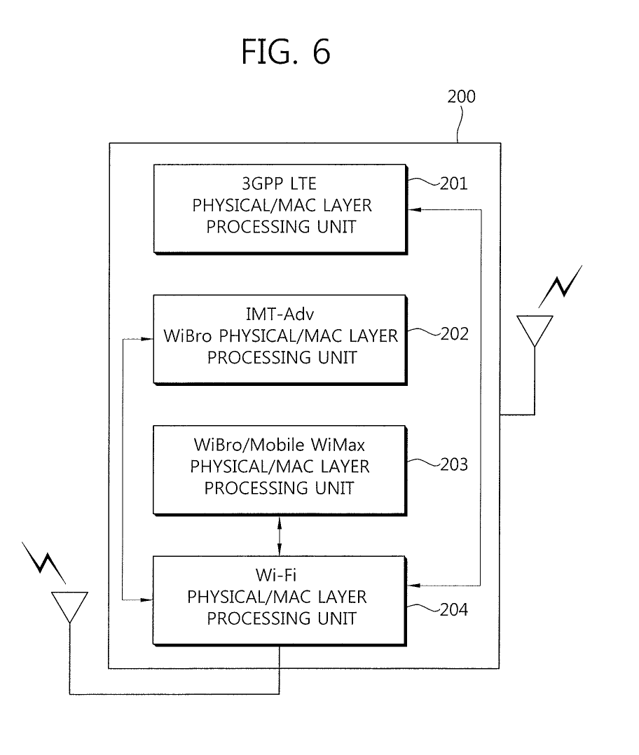

FIG. 6 is a diagram showing an example of a signal converting apparatus between wireless access networks according to an exemplary embodiment of the present invention.

Referring to FIG. 6, the signal converting apparatus 200 between the wireless access networks includes a 3GPP physical/MAC layer processing unit 201, an IMT-Adv WiBro physical/MAC layer processing unit 202, a WiBro/Mobile WiMax physical/MAC layer processing unit 203, and a Wi-Fi physical/MAC layer processing unit 204. It is assumed that FIG. 6 shows the signal converting apparatus between the wireless access networks that converts signals from various wireless access networks into the Wi-Fi signals for the Wi-Fi single mode terminal. In this case, the Wi-Fi physical/MAC layer processing unit 204 may be a targeted physical/MAC layer processing unit. Therefore, the 3GPP physical/MAC layer processing unit 201, the IMT-Adv WiBro physical/MAC layer processing unit 202, and the WiBro/Mobile WiMax physical/MAC layer processing unit 203 are each connected to the Wi-Fi physical/MAC layer processing unit 204 and can convert each wireless signal into the Wi-Fi signals. However, the exemplary embodiments of the present invention are not limited thereto. The signal converting apparatus 200 between the wireless access networks may communicate with the base stations of each wireless access network through an antenna or communicate with the single mode terminal through another antenna.

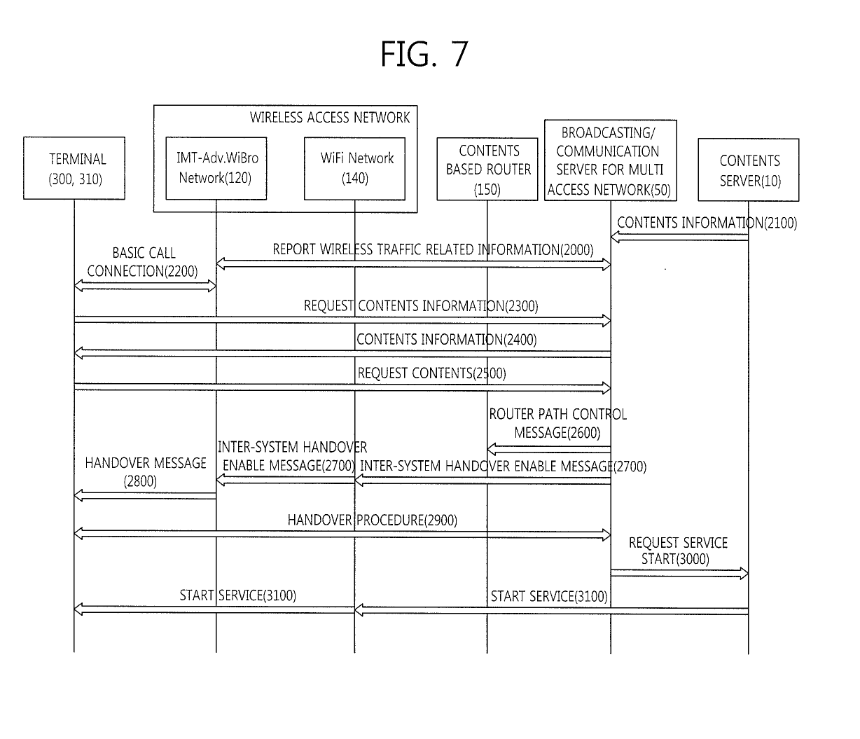

FIG. 7 is a diagram showing a method for selecting a wireless access network according to an exemplary embodiment of the present invention.

1) The plurality of wireless access networks 110, 120, 130, and 140 periodically report the wireless traffic related information of each wireless access network to the broadcasting/communication server 50 for a multi access network. The wireless traffic related information may include wireless resource allocation information of each wireless access network, available wireless resource information, interference information within each wireless access network, and the like.

2) The contents server 10 provides the contents information to the broadcasting/communication server 50 for a multi access network (2100).

3) The terminals 300 and 310 access the plurality of wireless access networks 110, 120, 130, and 140. In this case, the terminals may access the specific wireless access network due to performance of a basic call connection (2200). In this case, the terminals 300 and 310 may access the wireless access networks according to previously input procedures. For example, the terminals 300 and 310 may access the wireless access networks having the strongest signal strength.

4) When the terminals 300 and 310 request the contents information to the broadcasting/communication server 50 for a multi access network (2300), the broadcasting/communication server 50 for a multi access network transmits the contents information received from the contents server 100 to the terminals 300 and 310 (2400).

5) The terminals 300 and 310 request the transmission of the specific contents to the broadcasting/communication server 50 for a multi access network based on the received contents information (2500). The broadcasting/communication server 50 for a multi access network calculates the cost function to select the optimal wireless access network and transmits the router path control message to control the contents based router 150 (2600). In addition, the broadcasting/communication server 50 for a multi access network transmits an inter-system handover enable message to the wireless access network and the selected wireless access network that are currently accessed thereto to prepare handover between the wireless access networks (2700).

6) The wireless access network to which the terminals 300 and 310 are currently accessed receives the inter-system handover enable message from the broadcasting/communication server 50 for a multi access network and then, transmits the handover message to the terminals 300 and 310 (2800). Therefore, the handover is performed between the wireless access network and the selected wireless access network to which the terminals 300 and 310 are currently accessed (2900).

7) When the handover performance is completed, the broadcasting/communication server 50 for a multi access network requests a start of services to the contents server 10 (3000) and the contents server provides contents to the terminals 300 and 310 through the selected wireless access network (3100).

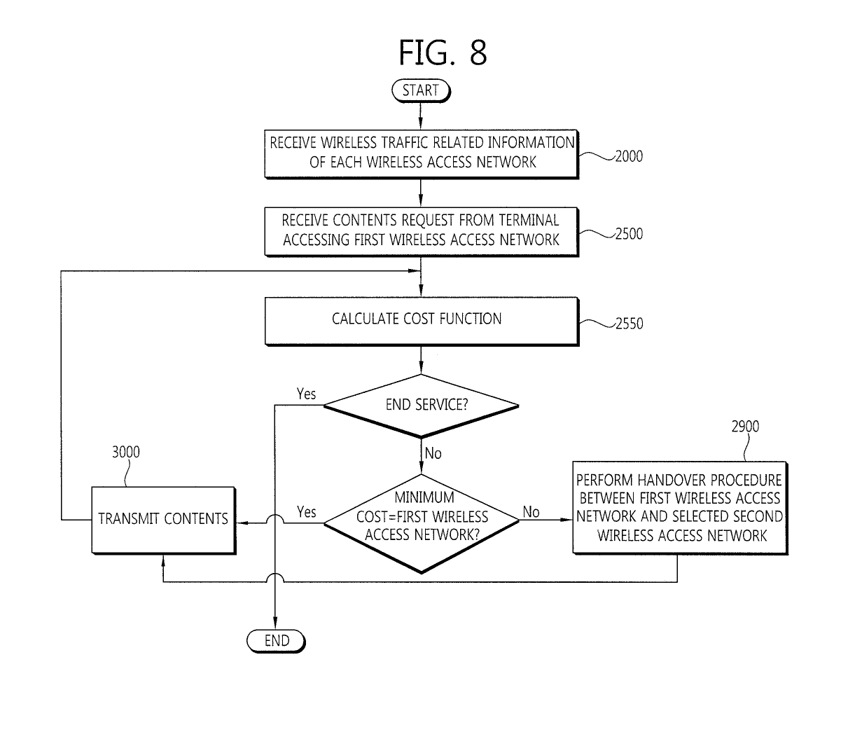

FIG. 8 is a diagram showing a method for selecting a wireless access network according to another exemplary embodiment of the present invention.

Referring to FIG. 8, the broadcasting/communication server for a multi access network periodically receives the wireless traffic related information of each wireless access network from the plurality of wireless access network (2000). Therefore, the state of each wireless access network may be periodically updated. When the broadcasting/communication server for a multi access network receives a contents transmission request from the terminals accessing a first wireless access network (2500), the broadcasting/communication server for a multi access network calculates the cost function of each wireless access network (2550). The cost function of each wireless access network may be continuously calculated later. The broadcasting/communication server for a multi access network compares the cost function of the first wireless access network to which the terminal is currently accessed with the cost function of another wireless access network and if it is determined that the cost of the first wireless access network is minimal, transmits contents through the first wireless access network (3000). When the cost of the second wireless access network different from the first wireless access network is minimal, the handover procedure between the first wireless access network and the second wireless access network is performed (2900) and the broadcasting/communication server for a multi access network transmits contents through the second wireless access network (3000).

According to the exemplary embodiment of the present invention, when the terminals request contents, each wireless access network and the optimal wireless access network is selected based on contents characteristics and thus, services are provided to users under the optimal conditions. To this end, each wireless access network periodically provides quality of service (QoS)/quality of experience (QoE) parameters to the broadcasting/communication server for a multi access network and the broadcasting/communication server for a multi access network may provide services to the terminals based on the parameters under the optimal conditions. The wireless access network is dynamically selected and used under variable wireless communication environments to obtain the traffic distributing effect of each wireless access network. In addition, even the users of the single mode terminal can access various wireless access networks through the signal converting apparatus between the wireless access networks, and therefore, the terminal purchasing costs of the users can be saved.

The present invention may be implemented by hardware and software or a combination thereof. Hardware may be implemented by an application specific integrated circuit (ASIC), digital signal processing (DSP), a programmable logic device (PLD), a field programmable gate array (FPGA), a processor, a controller, a microprocessor, other electronic units, or a combination thereof that are designed to perform the above-mentioned functions. Software may be implemented by a module performing the above-mentioned function. The software may be stored in the memory unit and executed by the processor. As the memory unit or the processor, various units well-known to those skilled in the art may be adopted.

According to the exemplary embodiments of the present invention, it is possible to provide contents to users through the optimal wireless access networks.

In the above-mentioned exemplary system, although the methods have described based on a flow chart as a series of steps or blocks, the present invention is not limited to a sequence of steps but any step may be generated in a different sequence or simultaneously from or with other steps as described above. Further, it may be appreciated by those skilled in the art that steps shown in a flow chart is non-exclusive and therefore, include other steps or deletes one or more steps of a flow chart without having an effect on the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. A broadcasting/communication server for a multi access network in wireless communication systems including a plurality of wireless access networks, comprising:
a wireless access network wireless resource cost comparing module configured to select one wireless access network by calculating a cost function of each of the plurality of wireless access networks, based on wireless traffic information of each wireless access network received from the plurality of wireless access networks and contents information to be provided to terminals;
a wireless router control module, operatively coupled to the wireless access network wireless resource cost comparing module, and configured to control a path of a contents based router with the selected one wireless access network; and
a network matching module configured to be connected to the plurality of wireless access network through the contents based router.

2. The broadcasting/communication server for a multi access network of claim 1, wherein the cost function is calculated based on the following Equation:
Cost=Weight×{(Contents required transmission rate)/(Allowable transmission rate in consideration of delay of each wireless access network)}×(cost of each wireless access network/bit),
where the weight is a parameter in consideration of characteristics of each wireless access network.

3. The broadcasting/communication server for a multi access network of claim 1, wherein the one wireless access network is selected as a wireless access network having the smallest cost function calculated.

4. The broadcasting/communication server for a multi access network of claim 1, wherein the wireless traffic information of each wireless access network includes at least one of wireless resource allocation information of each wireless access network, available wireless resource information, and interference information within each wireless access network.

5. The broadcasting/communication server for a multi access network of claim 1, wherein the wireless traffic information of each wireless access network is periodically received from each wireless access network.

6. The broadcasting/communication server for a multi access network of claim 1, wherein the contents information includes at least one of a bandwidth, a delayed value, and contents characteristics.

7. A method for selecting wireless access networks in wireless communication systems including a plurality of wireless access networks, the method comprising:
receiving wireless traffic information of each wireless access network from the plurality of wireless access networks;
receiving a contents transmission request from terminals;
selecting one wireless access network by calculating a cost function of each of the plurality of wireless access networks, based on the wireless traffic information of each wireless access network and contents information to be provided to the terminals; and
transmitting contents to the terminals through the selected one wireless access network.

8. The method of claim 7, wherein the cost function is calculated based on the following Equation:
Cost=Weight×{(Contents required transmission rate)/(Allowable transmission rate in consideration of delay of each wireless access network)}×(cost of each wireless access network/bit),
where the weight is a parameter in consideration of characteristics of each wireless access network.

9. The method of claim 7, wherein the one wireless access network is selected as a wireless access network having the smallest cost function calculated.

10. The method of claim 7, wherein the wireless traffic information of each wireless access network includes at least one of wireless resource allocation information of each wireless access network, available wireless resource information, and interference information within each wireless access network.

11. The method of claim 7, wherein the wireless traffic information of each wireless access network is periodically received from each wireless access network.

12. The method of claim 7, wherein the contents information includes at least one of a bandwidth, a delayed value, and contents characteristics.

13. The method of claim 7, further comprising controlling a path of a contents based router with the selected one wireless access network.

14. The method of claim 7, further comprising, when the selected one wireless access network is different from a wireless access network to which the terminals are currently accessed,
performing a handover to the selected one wireless access network from the wireless access network to which the terminals are currently accessed.

15. The method of claim 14, wherein the performing of the handover includes transmitting an inter-system handover enable message to a wireless access network to which the terminals are currently accessed and the selected one wireless access network.

16. A signal converting apparatus between a wireless access network in wireless communication systems including a plurality of wireless access networks, the signal converting apparatus comprising;
a target physical/MAC layer processing unit configured to convert wireless signals of other wireless access networks among the plurality of wireless access networks into wireless signals of the targeted wireless access network and process a physical/multimedia access control (MAC) layer of the targeted wireless access network; and
at least one source physical/MAC layer processing unit configured to process the physical/MAC layer of the other wireless access network.

17. The signal converting apparatus of claim 16, wherein the targeted wireless access network is a Wi-Fi network.

18. The signal converting apparatus of claim 16, wherein the other wireless access network is one of a 3^{rd} generation partnership project (3GPP) long term evolution (LTE) network, an international mobile telecommunications (IMT)-advance WiBro network, and a Wibro/Mobile WiMax network.

19. The signal converting apparatus of claim 16, wherein the target physical/MAC layer processing unit is further configured to communicate with a single mode terminal.

20. A communication method in wireless communication systems including a plurality of wireless access networks, the communication method comprising:
receiving wireless signals of other wireless access networks among the plurality of wireless access networks and converting the received wireless signals into wireless signals of a targeted wireless access network;
processing a physical/media access control (MAC) layer of the targeted wireless access network; and
communicating with a single mode terminal through the targeted wireless access network.
